(19) United States
(12) Patent Application Publication
(10) Pub. No.: US 2012/0285206 A1
(43) Pub. Date: Nov. 15, 2012

(54) THEFT-PREVENTION UNIT FOR A COMMERCIAL ITEM

(75) Inventor: Alain Favier, Nogent Sur Marne (FR)

(73) Assignee: EXAQTWORLD, Joinville Le Pont (FR)

(21) Appl. No.: 13/522,386

(22) PCT Filed: Jan. 19, 2011
(86) PCT No.: PCT/FR11/50096

§ 371 Date: Jul. 16, 2012

(30) Foreign Application Priority Data
Jan. 19, 2010 (FR) 1050340

(51) Int. Cl. E05B 73/00

(52) U.S. Cl. 70/19

(57) ABSTRACT

A theft-prevention unit (10; 50) for an item, includes a first portion (12) having a spike (16) intended for passing through the item or a packaging containing the item and a second portion (30; 52) provided with an opening (32b; 54b) for inserting the spike and also includes a locking element to prevent the retraction of the spike after the insertion thereof. The two portions are assembled together and maintained in assembled position according to two possible assembly modes: in a first prevention mode, the spike of the first portion is inserted in the opening of the second portion and the locking element is activated such that a user cannot separate the portions without using a tool; in a second provisional assembly mode, the two portions are mutually attached by a provisional attachment member such that a user can separate the two portions from one another without using a tool.

The invention relates to theft prevention, in particular shoplifting prevention, device for a packaged or unpackaged item.

In order to effectively counter shoplifting and more particularly the theft of certain products such as textile products (shirts, pullovers, underwear, pants, lingerie, neckties, socks, T-shirts, dresses, coats, hats, shoes, polo shirts, skirts etc.), as is known shop owners use anti-theft tags (also called EAS tags). These anti-theft tags set off an anti-theft gate or an RFID surveillance system arranged at the entry/exit points of a retail outlet such as a supermarket or hypermarket, a shop, a specialist store, a duty-free store, a department store, a museum, a video store, a drug store, and at the entry/exit points of any store or entity selling or displaying self-service items that may be stolen or removed without permission.

These tags are generally formed from two parts:
a body that contains a locking system and an active or passive member that triggers the detection scanners or gates that are commonly installed at the entry/exit points of stores,
a pin that passes through the item to be protected (for example the fabric of a garment) or the cardboard or plastic of blister packs.

The tags are generally transported from their place of manufacture to the retail outlets, directly or indirectly in two separate parts: the bodies are arranged in a container (box made from cardboard or another material) and the pins are in another container.

In the retail outlets, the staff place the tags on the items to be protected, each time taking a body from one container and a pin from another container, and then assembling them on the items in the locked position.

This operation is tedious, especially if the tags are not all identical and, for example, come in different colors. The bodies, on the one hand, and the pins, on the other hand, then need to be carefully selected, which entails a considerable amount of time.

It is moreover neither easy nor quick to pick up the pins because the people handling them generally try to avoid being injured by the spikes of the pins.

The bodies and the pins are sometimes enclosed in the same container for delivery and they then need to be sorted whilst avoiding injury.

It will also be noted that the pins can drop on the ground when they are being handled and, when they are lying on the ground with the spike upwards, this represents a risk for people walking through the store.

Furthermore, when a protected item passes through a checkout, the two parts of the tag are separated from each other after the locking system has been unlocked.

Each tag part is then collected in a different bin and the tags are replaced on other items, as described above.

Replacement has the same disadvantages.

The object of the invention is to overcome at least one of the abovementioned disadvantages by providing a theft prevention system comprising a first part having a spike intended to pass through the item or packaging containing the item, and a second part that, on the one hand, is provided with an orifice so that the spike can be inserted therein and, on the other hand, comprises locking means for preventing the spike from being withdrawn after it has been inserted, characterized in that the two parts are assembled together and held in the assembled position in two possible assembly modes, a first so-called prevention mode in which the spike of the first part is inserted into the orifice of the second part and the locking means are activated so that a user is unable to separate them without using a tool, and a second so-called temporary assembly mode in which the two parts are fixed to each other by means of temporary fixing means, these means being such that a user can separate the two parts from each other without using a tool.

By virtue of the second temporary assembly mode (this mode is used to handle the unlocked prevention system, for example to reduce the risk of injury to the people concerned), the two parts of the prevention system (e.g. an anti-theft tag) are fixed or coupled to each other (permanently in this mode) without being locked. In this mode, the free end of the spike of the first part is at least partly protected in order to reduce the risk of injury. In this respect, the spike is arranged inside the second part or against it. At least partly protecting the free end of the spike means that the free end is not necessarily surrounded on all sides by a wall. The free end of the spike can indeed be arranged against the second part (e.g. against an outer face of the latter) of the system and hence be partly surrounded by the second part, which partly protects this free end. In such an arrangement, the free space between the free end of the spike and the second part is not large enough for a person's finger to get caught in it and hence be injured on the free end.

More generally, the free end of the spike is at least partly protected when it does not project from the second part, moving away from the latter.

It will moreover be noted that by protecting the free end of the spike in this way it is also protected against premature wear. Such wear takes place gradually by gradually flattening the spike and indeed risks spoiling the items, in particular when they are made from textiles, by increasingly damaging the fibers.

By virtue of the invention, the usable life of a thin spike is therefore increased, thus enabling the fibers to be better separated without breaking them for longer than before. Indeed, in the prior art, in stores the first parts provided with spikes of the prevention systems are recycled separately from the second parts: the first parts provided with spikes are thrown loosely into a receptacle, which causes friction and impacts at the spikes, thus resulting in premature wear on them.

By virtue of the second assembly mode, it is thus easy to transport and handle each ready-to-use prevention system that joins together the two parts (in physical contact with each other) that are matched up, for example using corresponding colors or other identification codes.

The user then just needs to separate the two parts from each other, manually and without using a tool, and then place them on an item to be protected by assembling them in the first mode (by activating the locking system).

The various operations of selecting and handling the two parts situated in separate containers are avoided in this way.

The risk of injury is thus considerably reduced.

Moreover, once the two parts of the system have been assembled temporarily, they take up less space than the space occupied by each part separately.

This arrangement is advantageous for transporting and storing the prevention systems: there is no longer any need for two separate containers for each of the two parts of the prevention systems, a single container being sufficient, and, for example, a single commercial code is required for the prevention system.

The logistics and distribution network (ordering, supply, etc.) are thus simplified.

It is also made easier to recycle the prevention systems after items have passed through the checkout (no sorting) and there is a considerable saving in time.

According to one feature, the second part has at least one opening for inserting the spike of the first part into a hollow portion of the second part, said at least one opening being distinct from the orifice, the hollow portion being designed to receive the spike and hold it in a temporary assembly position.

The hollow portion allows the spike to be accommodated and hence protected so that it cannot injure people.

It will be noted that multiple openings distinct from the insertion orifice can be made in the second part to receive the spike.

According to one feature, the spike has a free end that is arranged inside the hollow portion in the second temporary assembly mode, so completely protecting the free end.

According to one feature, the opening and/or the hollow portion have dimensions that are sufficiently close to those of the spike that the latter is inserted with force and held in the temporary assembly position in the second mode.

Such a temporary assembly mode is particularly simple to achieve.

According to one feature, the second part comprises an inner wall and an inner member attached to the inner wall and defining a hollow portion with the latter to receive the spike.

According to one feature, the inner wall is substantially cylindrical and the inner member forms a ring that fits around the wall. The wall may be locally interrupted so that the spike can be inserted.

It will be noted that the ring can be elastic and the spike is inserted with force between the inner wall and the ring.

According to one feature, the second part has an inner member interacting with the spike accommodated in the hollow portion so as to exert a mechanical force on said spike that tends to prevent it from being withdrawn.

According to this embodiment, the spike can be inserted into the second part more easily than in the previous embodiment in which the spike is force-fitted.

According to one feature, the inner member is integral with a wall of the second part and can, for example, take the form of an elastically mounted tongue.

The temporary assembly or fixing member is thus manufactured with the second part of the prevention system and is invisible from outside.

According to one feature, the second part has a first face in which the orifice for inserting the spike is made.

According to one feature, the opening for the temporary assembly is arranged on the first face of the second part at a distance from the orifice for inserting the spike.

In this embodiment, a distinct specific opening is provided for temporarily assembling the two parts to each other.

Because the opening is arranged on the same face as that of the insertion orifice, it is particularly simple to effect the temporary assembly since the habits of the staff responsible for handling the prevention systems are substantially unchanged.

Moreover, when the two parts are assembled temporarily by this specific opening, the two parts are offset radially instead of being centered on each other (as is the case in the locked position), which makes it very easy to identify the temporary assembly mode.

According to one feature, the second part has a second opposite face and the opening for temporary assembly is arranged on the second face.

According to one feature, in the second temporary assembly mode the spike is inserted into the orifice and the prevention system has a means that temporarily deactivates the locking means.

In this embodiment, for example there is no additional opening provided for temporarily assembling the two parts and the insertion orifice of the spike is used for the temporary assembly, which proves to be even more practical for the staff responsible for handling the prevention systems.

It is thus possible to insert the spike into the orifice without the two parts being locked to each other and requiring a specific tool to separate them.

However, this second temporary assembly mode is not incompatible with a third temporary assembly mode that may be used later. It may indeed be envisaged to use the second temporary assembly mode (orifice and means for temporarily deactivating the locking means) for the first time that the system is deployed. Once the deactivation means has been removed, the prevention system can be handled using a third temporary assembly mode such as a distinct opening of the orifice.

According to one feature, the second part of the prevention system forms a casing.

This casing can take various forms and, for example, can have a first substantially plane face and a second opposite convex face.

However, the casing can also adopt a thin, substantially parallelepipedal shape.

It will be noted that the casing of the prevention system generally has at least one active or passive member which is capable of emitting electromagnetic waves to the outside of the prevention system or of receiving such waves from an external source.

The active or passive member or members which is/are capable of interacting with an outer complementary theft prevention/detection system (an anti-theft gate, for example) and triggering an alarm is/are thus housed in the casing.

The member carried by the casing is, for example, a passive member that receives electromagnetic waves when it is situated in proximity to the complementary system.

Such a passive member is, for example, a resonating electrical circuit which starts to resonate in a known fashion under the action of exciting waves emitted at the resonating frequency of the circuit.

In an alternative embodiment, it will be noted that the active or passive members that fulfill a theft prevention/detection function can be situated in the first part of the prevention system and not in the section part forming a casing.

According to one feature, the hollow portion is formed in the casing, at its periphery, and the opening that opens into the hollow portion is made in an outer face of said casing. The hollow portion is thus made in the thickness of said casing. A cutout is, for example, made in the casing for inserting and receiving the spike of the first part in this cutout that forms the hollow portion. Such a cutout is, for example, a groove/throat made in the periphery of the casing, for example in an edge of the casing (within its thickness).

This cutout thus makes it possible to house the free end of the spike and hence not only to temporarily associate the two parts with each other but also to protect people from being injured when handling the prevention systems.

According to one feature, the first part having the spike is temporarily fixed to an outer face of the second part of the prevention system in such a way that the free end of the spike is arranged along this outer face, substantially parallel to it. The spike can, for example, be fixed to the outer face and arranged parallel to it.

This temporary fixing can take the form of temporarily bonding the first part to the second part.

A spot of glue may, for example, be sufficient to hold the two parts together temporarily.

The first part is generally arranged against the second part so that the free end of the spike does not project with respect to the second part, moving away from it, this being so in order to prevent a risk of injury.

Other features and advantages will be come apparent from the following description, given purely by way of non-limiting example and made with reference to the attached drawings, in which:

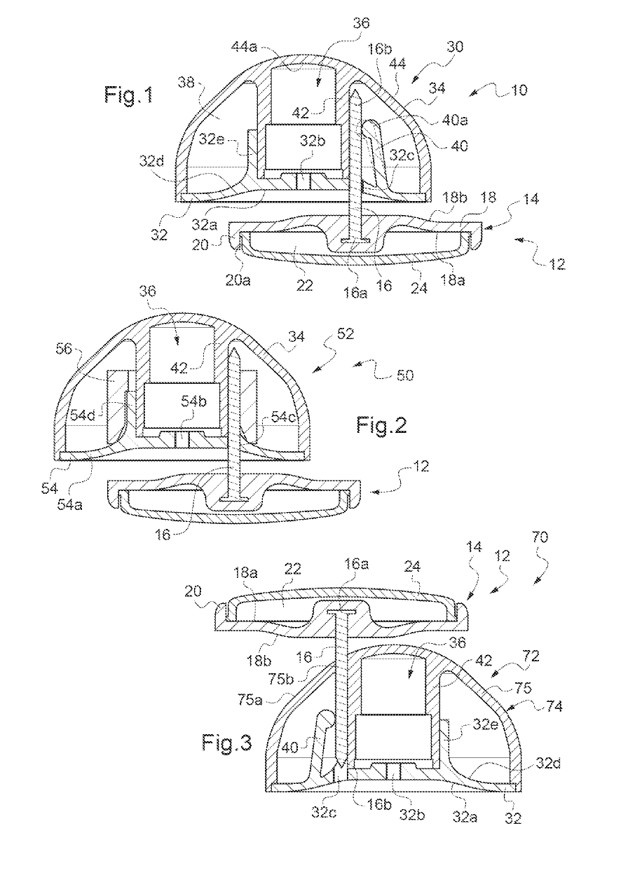

FIG. 1 is a schematic view in longitudinal section of a prevention system in the temporary assembly position in a first embodiment of the invention;

FIG. 2 is a schematic view in longitudinal section of a prevention example in the temporary assembly position in a second embodiment of the invention;

FIG. 3 is a schematic view in longitudinal section of a prevention system in the temporary assembly position in a third embodiment of the invention;

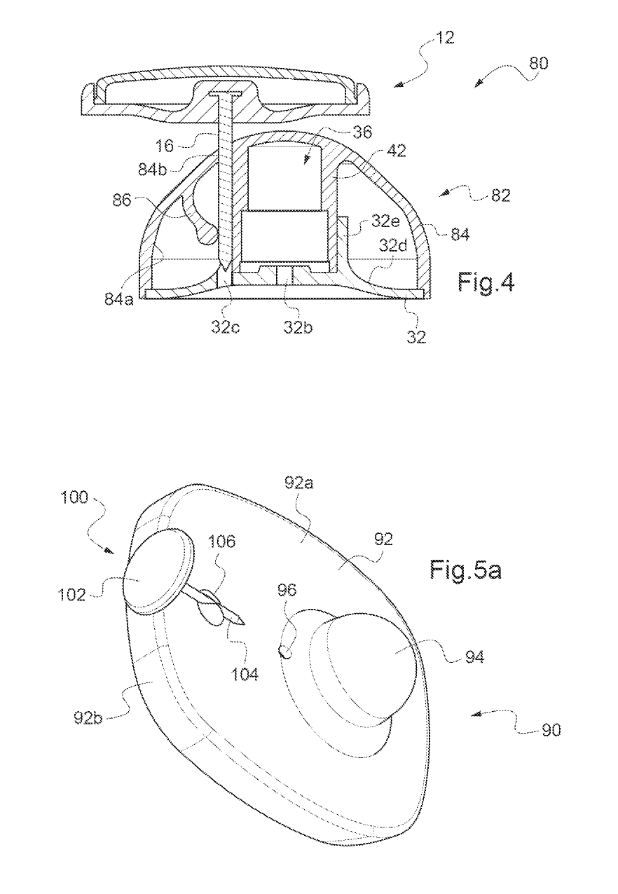

FIG. 4 is a schematic view of a prevention system according to an alternative embodiment of FIG. 3;

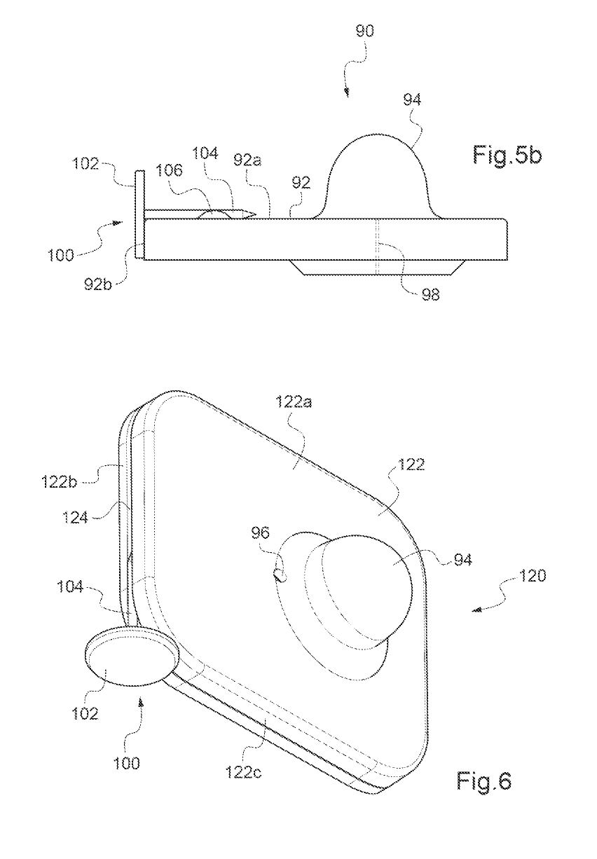

FIGS. 5a and 5b are schematic perspective views of a prevention system in the temporary assembly position in a fourth embodiment of the invention;

FIG. 6 is a schematic perspective view of a prevention system in the temporary assembly position in a fifth embodiment of the invention;

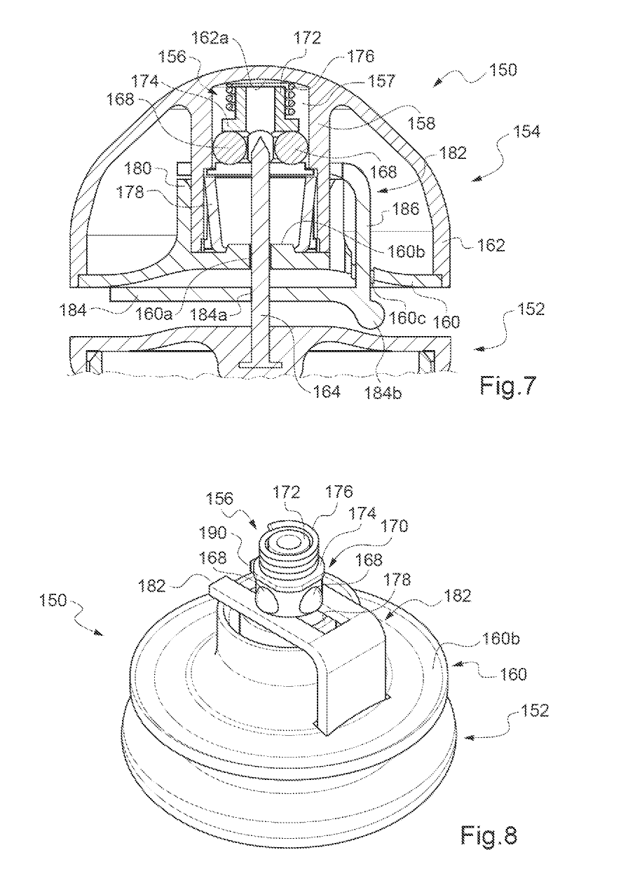

FIGS. 7 and 8 are schematic perspective views of a prevention system in the temporary assembly position in a sixth embodiment of the invention, FIG. 8 comprising a partial perspective view of the inside of the casing of the prevention system in FIG. 7.

As shown schematically in FIG. 1, a theft prevention system for a commercial item (for example, a garment) designated by the general reference numeral 10, comprises a first part having a head 14 equipped with a spike 16 intended to pass through the item or packaging, for example of the blister pack type, containing the item.

The head more particularly comprises a first portion 18 having the general form of a plate 18, in the central part of which is mounted an end 16a of the spike that forms the head of the latter.

It will be noted that the central part of the plate 18 is thicker than the remainder of the latter so that the head 16a of the spike can be housed therein.

The portion forming the plate 18 has an annular rim 20 that extends in the opposite direction to the spike so as to form an internal housing 22 delimited partially by the base of the plate 18a and partially by the annular rim 20.

It will be noted that the portion forming the plate 18 has a face 18b opposite the face 18a and from which the body of the spike 16 extends substantially perpendicularly.

A protective cap 24 closes the housing 22, bearing against the inner face of the annular rim 20, for example being inserted onto a shoulder 20a formed on this face.

The housing 22 has, for example, a printed insert that can be seen from outside the head 12 thanks to the optical properties (transparency, for example) of the cap or window 24.

The prevention system, also known as an anti-theft tag, also comprises a second part 30 having the general form of a casing that, in the example shown in FIG. 1, comprises two portions.

A first portion 32 is akin to a plate with a substantially plane shape having a first face 32a in which is formed an orifice 32b passing through the thickness of the plate so that the spike 16 can be inserted in the conventional locked assembly mode.

The second part 30 also has a second portion 34 with a general convex shape that here assumes, for example, the shape of a dome or a substantially hemispherical shape.

This second portion is hollow overall so that a certain number of elements can be housed therein and has, in an equatorial plane, an opening that is here closed by the plate 32 provided with the orifice for inserting the spike.

The second portion 34 comprises a central cavity 36 in which locking means are arranged that are intended to prevent the spike 16 from being withdrawn when it is introduced through the insertion orifice 32b.

This central cavity is delimited by an inner wall 42, which is for example cylindrical, that extends from the inner face 44a (base) of the wall 44 defining the outer shell of the casing and is open at its opposite end.

In its central portion, the plate 32 has a projecting portion 32e forming an inner wall that is, for example, substantially cylindrical.

This wall 32e is mounted so that it fits tightly against the wall 42 and surrounds virtually all of it except for a point where the wall 32e is locally interrupted to receive the spike 16.

In an alternative embodiment not shown, the wall 32e continuously surrounds the inner wall 42 of the central cavity and the spike 16 is wedged between the wall 32e and the pressing/immobilizing member 40.

The locking means have not been shown in FIG. 1 for greater clarity.

These are means known per se such as ball locking means.

Such means comprise, for example, multiple balls placed in a funnel inside the cavity 36, in a same plane and which form a central space between them to receive the spike 16.

When the spike is inserted into the space between the balls, the balls are wedged in the converging part of the funnel.

Any attempt to withdraw the spike axially tends to push the balls further into the converging part of the funnel and hence to jam the spike.

It will be noted that the balls are metal and more particularly are made from a magnetic material, which makes it possible to extract them from the converging part of the funnel under the action of an external magnetic field.

At the periphery of the cavity 36, the second portion 34 also comprises an annular chamber 38 in which a member is arranged, or even multiple members that are for example passive, i.e. can receive electromagnetic waves originating from a source outside the prevention system 10.

Such a member can, for example, take the form of an LC-type resonating circuit. Alternatively, the casing can enclose one or more active members, i.e. members that are capable of emitting electromagnetic waves from the inside to the outside of the prevention system.

It will be noted that such active or passive members are, for example, ferrite coils with or without a capacitor, LCR circuits, magnetic filaments, RFID-type circuits equipped with an active or passive memory chip, etc. This member or these members interact(s), via the transmission of electromagnetic waves, with an external detection system such as a gate or scanner placed at an entry/exit point of the store in which the items to be protected are sold, in order to trigger an alarm detecting the prevention system at the entry/exit point.

This member or these members has/have not been shown in FIG. 1 for greater clarity.

As shown in this figure, the plate 32 comprises, arranged on its first face, an opening 32c passing through the thickness of the plate and arranged parallel to the insertion orifice 32b, distinct from and at a distance from it.

This opening is provided for temporarily assembling the first part 12 with the second part 30.

As shown in FIG. 1, the spike 16 of the first part 12 is inserted into the opening 32c and is engaged inside the annular chamber 38 over the majority of its length so that the free end 16b is arranged inside this hollow portion of the casing.

It will be noted that the opening 32c is arranged at the point where the wall 32e is locally interrupted and the dimensions of this recess are adapted to receive the spike between the two interrupted wall portions and the wall 42.

An inner member of the casing is provided inside the latter in order to exert a mechanical force on the spike 16 that tends to prevent this spike from being withdrawn.

It will be noted that this inner member is, for example, integral with an inner wall of the casing and, for example, takes the form of a tongue 40, this tongue having a small degree of elasticity so that it can adopt two positions.

In a first position illustrated in dashed lines in FIG. 1, the tongue is slightly inclined so that it is situated in the path of the spike 16 when it is inserted through the opening 32c and during its progression inside the hollow portion of the casing.

When, as it progresses, the spike meets the tongue 40, it moves the latter slightly away from its first position owing to its elasticity so that it occupies a second position that is shown in solid lines in FIG. 1.

In this second position, the tongue exerts an elastic restoring force on the spike 16 and hence exerts a compressive force tending to hold it against the inner wall 42 delimiting the central cavity 36, in the groove made in the inner wall 32e.

It will be noted that the free end of the tongue 40, i.e. its end not fixed to the plate forming the support 32, a thicker part that forms a protuberance 40a intended to come into contact with the spike 16.

This part is thicker than the part forming the body of the tongue so that it is more resistant, in particular to wear.

It will be noted that, in the example illustrated in FIG. 1, the tongue 40 is integral with the inner face 32d of the plate 32, opposite the first face 32a.

In an alternative embodiment that is not shown, however, the inner member can be integral with the wall 44 of the casing 30.

In the position shown in FIG. 1, the two parts 12 and 30 are assembled/fixed together temporarily to allow them to be transported and handled better than in the prior art and in particular without any risk of one of the two parts being lost.

The free end of the spike of the first part is thus hidden from the outside, which prevents any risk of people handling the system being injured and also protects the free end against premature wear (from inadvertent impacts, contact, etc.).

Furthermore, this temporary assembly mode is particularly practical since the people handling such a prevention system can disassemble the two parts without having to use a special tool.

Indeed, all that is required is to exert a force with one hand to withdraw the first part while holding the second part with the other hand.

All that is then required is to place the first part and the second part on an item in a known fashion in order to assemble them in the locked theft prevention position.

It will furthermore be noted that the temporary assembly mode in FIG. 1 makes it possible to save space when transporting the prevention system and also when storing it.

Integrating temporary assembly means into the prevention system thus gives the prevention system a new feature since it is thus possible to handle this system with the two parts joined together with no locking.

The prevention system 50 according to a second embodiment of the invention illustrated in FIG. 2 comprises a first part 12 that is identical to the one with the same reference numeral in FIG. 1 and a second part 52 having most of the elements that have already been described with reference to FIG. 1 and that have the same reference numerals.

However, in this second embodiment, a different type of inner member is provided for interacting with the spike 16 so as to prevent the latter from being withdrawn inadvertently after it has been inserted into the hollow portion of the casing 52.

This inner member here forms an attached part, which has the advantage of requiring very few modifications when the casing is manufactured.

More particularly, the casing 52 comprises a first portion 54 that has the general form of a plate closing the hollow second portion 34 with a domed outer shape.

This first portion 54 has a first face 54a in which are formed the orifice 54b for inserting the spike which is identical to the orifice 32b and the opening 54c for temporarily assembling the first part which is identical to the opening 32c in FIG. 1.

However, the plate does not have a member 40 as in FIG. 1.

On the face opposite the first face 54a, in its central part the plate 54 has a generally cylindrical projecting portion that surrounds the cylindrical wall 42 defining the central cavity 36 virtually over its entire circumference.

The projecting part 54d forms as it were a hub around the cylindrical wall 42 with the exception of the zone situated in proximity to the opening 54c that is interrupted locally (like the wall 32e in FIG. 1) to allow the spike 16 to be arranged against the outer face of the wall 42.

An inner member 56 in the form of an annular ring (or washer) surrounds the hub 54d and is force-fitted around it before the plate 54 is installed in position to close the casing in the manner of a lid.

This member is, for example, made from an elastic material such as rubber.

The spike 16 is then inserted into the opening 54c and then slid along where a zone of the hub 54d has been removed (a groove) between the ring 56 and the wall 42.

The spike 16 is thus force-fitted into this hollow portion situated inside the second part 52 and with dimensions that are sufficiently close to those of the spike to prevent it from being withdrawn axially too easily.

This immobilizing and temporary assembly/fixing position allows the two parts of the system 50 to be displaced together without any risk of them becoming disassembled inadvertently or as a result of clumsiness.

To uncouple these two parts, as in the first embodiment in FIG. 1 all that is required is to firmly move the two parts apart in the axial direction of the spike 16.

The same advantages as those described in relation to FIG. 1 apply here too and will thus not be repeated.

The prevention system 46 illustrated in FIG. 3 shows a third embodiment according to the invention.

This system comprises two parts, namely the first part 12 which is identical to that in FIG. 1, and a second part 72 that is slightly modified from the second part 30 in FIG. 1.

As in the embodiment in FIG. 1, the second part 72 comprises a first portion 32 forming a substantially plane closing plate for the second portion 74 forming the hollow body of the casing.

The first face 32a of the plate 32 has the same orifices and openings 32b and 32c respectively and the inner member 40, made for example in the form of an elastically mounted tongue, is also integrally connected to the opposite face 32d of the plate 32 as in FIG. 1. The drawing in FIG. 3 has just been reversed compared with that in FIG. 1.

As in the embodiment in FIG. 1, the second part 72 has, in the form of its second portion 74, a domed outer shape.

The outer face 75a of the wall 75 defining the outer shell of this second portion (the wall 75 defining the outer shell with a face opposite the first face 32a of the first portion) is pierced by an opening 75b to allow the spike 16 to be temporarily inserted into it from the side of this domed face.

Because the plate 32 (front face) is substantially plane, the second part 72 can be placed on a plane surface (for example, a table) in the position illustrated in FIG. 3 to make it easier to install the spike in the rear face.

Moreover, the spike installed in the rear face of the casing makes it possible to stabilize the system in the containers during transport.

This arrangement makes it possible to easily identify the temporary assembly mode visually.

It will be noted that, as above, the central extended portion or wall forming the hub 32e does not surround the wall 42 over its entire periphery so as to form a space for inserting the spike 16.

As in the other embodiments, the recess made in the wall 32e allows the spike 16 to be positioned as close as possible radially to the central part of the body of the casing (which for example displays rotational symmetry), where the height of the casing is greatest. This arrangement allows a spike to be housed more easily without making too many modifications to the second portion 74.

The opening 75b is arranged at the periphery of the cylindrical wall 42 defining the central cavity 36 so as to allow the spike 16 to be arranged against the outer face of the wall 42 and held against it in the interrupted zone of the wall 32e by means of the inner member 40.

This member acts in the same way as in the embodiment in FIG. 1.

It will moreover be noted that the opening 75b is aligned with the opening 32c in the example illustrated in FIG. 3.

These two aligned through openings can be made in a particularly simple fashion in a single operation.

These openings may, however, for various reasons be designed so that they are unaligned.

The advantage of having these two openings is that the two parts of the system can be assembled together temporarily using either of the openings.

Moreover, in the embodiment illustrated in FIG. 3, the presence of the opening 32c allows spikes of different lengths to be housed inside the second part 72 through the opening 75b. Users stop pushing the spike of the first part inside the casing when they see the end 16b of the spike 16 about to emerge from the end 32c.

All of the features already mentioned above apply here too and will not be repeated.

An alternative embodiment of the prevention system in FIG. 3 is illustrated in FIG. 4.

The prevention system 80 in FIG. 4 has the same first part 12 and a second part 82 that is slightly modified from the second part 72.

Indeed, the inner member of the second part 82 is integral with the inner face 84a of the wall 84 of the casing and not with the plate 32 forming a lid to close the casing.

This arrangement can be selected depending on the internal space available and the internal arrangement of the casing.

The inner member 86 is also elastic like the inner member 40 and is shown in FIG. 4 with a slightly curved shape that extends from the inner face of the wall 84 inside the casing toward the central wall 42. The purpose of the curved shape is to act elastically on the spike 16 introduced through the opening 84b of the wall 84 by exerting pressure on the spike in order to hold it in position inside the casing against the wall 42.

The same advantages as described in relation to the previous figure apply here too and will not be repeated.

It will be noted that different embodiments can be envisaged for forming temporary assembly or fixing means for the two parts of a prevention system.

In particular, the inner member illustrated in FIGS. 1 to 4 can take different forms for performing the function of holding the spike in the hollow portion of the second part of the prevention system.

It will also be noted that the opening or openings that allow(s) the spike to be inserted with a view to temporarily assembling the two parts can be arranged differently and, for example, are not necessarily aligned as in FIG. 4.

In the examples illustrated in the figures, these openings have been arranged in order to allow a spike that is as long as possible to be introduced inside the casing.

It is for this reason that the openings have been arranged at the immediate periphery of the central wall 42, where the thickness of the casing is close to its maximum dimension and there is a small amount of free space.

FIGS. 5a and 5b illustrate a fourth embodiment of a prevention system according to the invention.

The system 90 corresponds to a different type of anti-theft tag in which the casing has a planer shape than the casings above. It has a substantially parallelepipedal general shape.

This casing thus takes the form of a thick plate 92 from which extends, substantially perpendicular to this plate, a portion 94 forming a bell-shaped part inside which locking means for the spike of the part 100 that will be described later are generally arranged. The flatter remainder of the casing encloses the active or passive anti-theft member(s) capable of emitting or receiving electromagnetic waves originating from a source outside the system.

This member or these members is/are similar to those described with reference to the previous figures and has/have the same features.

It may, for example, be a flat resonating LC circuit.

It will be noted that an opening 96 (FIG. 5a) passing through the thickness of the casing is made at the base of the extension portion 94 and serves for the insertion of a cable which is generally used to fix the prevention system around an item or packaging.

On its face opposite the face that can be seen in FIG. 5a, the system 90 has an insertion orifice 98 shown in dashed lines in FIG. 5b (side view).

The system 90 also has the part 100 comprising a head 102 provided with a spike 104 which is intended to be inserted into the orifice 98 in FIG. 5b, so enabling the two parts 92 and 100 to be assembled and locked together by activating the locking means arranged inside the bell-shaped portion 94.

It will be noted that, in this locked assembly position, the two parts can only be separated from each other using a specific tool such as, for example, a sufficiently powerful magnet.

FIGS. 5a and 5b illustrate a temporary assembly mode for the two parts of the prevention system that makes use of particularly simple assembly or fixing means since there is no need to make any modifications to any of the parts.

Indeed, the first part 100, termed a “pin”, is fixed temporarily to the second part 92 using glue.

In particular, a spot of glue 106 allows the first part 100 to be positioned temporarily against an outer face, for example 92a, of the second part.

The glue used is, for example, the type used for gluing various promotional sachets or packaging to the pages of magazines, especially women's magazines.

It allows the sachets and packaging to be positioned temporarily without the surfaces being glued firmly together.

The glue may then be easily removed by rubbing, leaving no marks. It is a temporary adhesive, for example a pressure-sensitive type, that allows two objects to be positioned and repositioned relative to each other without spoiling their surfaces.

The first part is arranged against the second part in such a way that the spike 104 does not project from the casing 92 (in particular its face 92a), moving away from the latter.

The spike is thus, for example, arranged along one of the faces (for example, the face 92a) of the casing, parallel to this face and against it and for example in the direction of the central part of this face.

The free end of the spike 104 is thus very close to the face 92a, so preventing a user's finger from coming into contact with the free end.

As shown in the figure, one possible arrangement is one in which the head 102 of the first part 100 bears against (abuts) the edge 92b of the plate 92 with its inner face, the spike 104 being glued against an outer face of the casing perpendicular to the edge 92b.

Other geometric arrangements can, of course, be envisaged.

In the arrangement illustrated in the figures, the spike points toward the center of the casing and there is hence no risk of injuring anyone.

It will be noted that one or more spots of glue may be provided to temporarily assemble the two parts more securely, for example if the spike is particularly long.

The free end of the spike could possibly be covered with glue to protect it.

In another alternative embodiment, a spot of glue could be provided on the inner face of the head 102 intended to be positioned against the edge 92b, in addition to or instead of the spot 106.

FIG. 6 illustrates a fifth embodiment of the invention that essentially replicates the two parts of the prevention system 90 in FIGS. 5a and 5b.

Elements that are unchanged from FIGS. 5a and 5b have the same reference numerals.

The first part 100 (the pin) having the head 102 and the spike 104 are thus unchanged, whilst the plate forming a casing 92 in FIGS. 5a and 5b has been slightly modified.

The plate 122 still has a bell-shaped portion 94 mounted on top of its face 122a, to receive the locking means of the spike 104, and has a peripheral cutout 124.

This cutout forms a hollow portion or throat intended to receive the spike 104 in order to hold it there in the temporary assembly position.

As shown in FIG. 6, the cutout is made on a portion of the edge 122b of the casing (within the thickness of the casing), perpendicular to the upper face 122a of the latter.

The cutout 124 here has the form of a groove with a depth that substantially corresponds to the diameter of the spike 104 so that the latter can be housed therein without projecting from the outer face of the edge 122b, moving away from it.

The length of the groove 124 here substantially corresponds to that of the edge 122b, to facilitate manufacture.

As shown, the spike 104 is introduced at one of the ends of the edge 122b and then slides inside the groove until the inner face of the head 102 comes into contact with another edge of 122c of the casing, perpendicular to the first edge 122b.

The dimensions of the groove are adjusted such that the spike 104 is introduced with a small degree of force, so enabling it to be held temporarily until it is desired to withdraw it.

It will be noted that other cutouts or hollow portions can be arranged in other zones of the casing where the dimensions are sufficient to allow the spike 104 to be inserted and positioned.

The advantage of a cutout made on the edge is that it is relatively invisible from outside.

It is additionally easy to produce since it is situated in the zone of the join between the two half-casings forming the casing 122.

The arrangement illustrated in FIG. 6 represents minimal modifications to the casing that do not compromise its whole design and in particular its internal arrangement.

In other forms of the casing, the cutout can be made in a different fashion.

It will be noted that, in the embodiments illustrated in FIGS. 5a, 5b and 6, the head 102 of the first part generally serves as an abutment for positioning the first part on one of the outer faces of the casing.

FIGS. 7 and 8 illustrate a sixth embodiment of a prevention system according to the invention.

The prevention system illustrated in these Figures always has two parts, namely a first part equipped with a head and a spike identical to that in FIG. 1, and a second part forming a casing provided with an insertion orifice so that the spike can be inserted therein and which is equipped with locking means so that, once the spike has been inserted, it cannot be withdrawn axially.

In this embodiment, the temporary assembly mode provides that the spike is inserted into the insertion orifice without making use of another opening for inserting the spike and has a means that, when installed, temporarily deactivates the locking means or prevents these means from being activated.

In the example shown in FIG. 7, the prevention system 150 has a first part 152 identical to the first part 12 in FIG. 1, and a second part 154 forming a casing and having locking means 156 housed inside a substantially cylindrical central cavity 157 delimited by a cylindrical inner wall 158.

It will be noted that the active or passive anti-theft security member(s) is/are generally housed in the annular chamber surrounding the cavity 157.

A plate 160 closing the generally dome-shaped casing 162 is provided with an orifice 160a for inserting the spike 164.

As shown in FIGS. 7 and 8, the cavity 157 encloses ball locking means 156 comprising multiple balls, for example four, referenced 168 which are mounted in a cage 170 and project from the outer wall of the latter as shown in FIG. 8.

FIG. 8 shows the interior of the casing without the wall of the casing 162.

A piece 172 with a substantially cylindrical shape provided with a horizontal shoulder 174 at its base is mounted on top of the upper part of the cage.

It will be noted that the piece 172 forms, for example, an integral part of the cage 170.

A spiral compression spring 176 is mounted around this piece 172 and bears, on the one hand, on the shoulder 174 at one of its ends and, on the other hand, on the inner face 162a of the wall 162 at the base of the central cavity 157.

A funnel-shaped piece 178 is situated in the lower part of the central cavity 157 and has a shape that converges slightly toward the open end of the cavity 157.

As shown in FIG. 7, thus piece forming a funnel 178 bears against the inner face 160b of the closing plate 160 that is fitted around the cylindrical wall 158 by means of its central hub 180, in an identical fashion to the mounting shown in FIGS. 1 to 4.

In the absence of the invention, the balls 168 are arranged in the piece forming a funnel 178 and are pushed by the spring 176 toward the base of the funnel (open end of the wall 157).

When the spike 164 is introduced into the orifice 160a and penetrates inside the cavity 157, the balls are wedged in the lowest part of the converging piece and are held in this position by means of the spring 176, so locking the spike inside the second part 154.

In the embodiment shown in FIGS. 7 and 8, an intermediate piece 182 performs the role of a means for temporarily assembling the two parts of the prevention system 150 and will now be described.

This piece forms a means that has the purpose of temporarily deactivating the locking means 156 (or of preventing them from being activated).

The piece 182 has a baseplate 184 from which an upright part 186 extends, substantially perpendicular to said baseplate for a certain distance until the end of this upright part curves slightly and is provided with two arms 188, 190 that extend substantially parallel to the baseplate and to each other.

These two arms give this part of the piece 182 the general shape of a fork, as shown in FIG. 8. The intermediate piece 182 is pierced in its baseplate 184 by a through orifice to allow the spike 164 to pass through.

A through opening 160c is made in the thickness of the plate 160 in order to allow a part of the piece 182, especially the upright part 186 of the associated fork, to pass through.

The baseplate 184 of the piece 182 has an extension 184b forming as it were a grab handle so that the piece 182 can be handled easily, in particular when placing it in or withdrawing it from the casing.

As shown in FIGS. 7 and 8, the intermediate piece is installed in position, partly inside the casing, with the upright part 186 and the fork arranged inside the second part 154.

It will be noted that the piece 182 is flexible, which allows it to be easily placed through the opening 160c and withdrawn.

For its part, the support 184 remains outside the second part and is arranged parallel to the plate 160 and opposite the latter.

In this position, the fork is wedged beneath the balls 168, as shown in FIG. 8, more particularly beneath the cage enclosing the balls, in order to hold them in the upper position and to prevent them from being positioned in the converging part 178.

This installation generally takes place in the factory before the prevention systems are delivered. More particularly, this installation takes place when mounting the various internal components of the casing.

The unit formed by the locking means 156 is confined in the part of the central cavity close to the wall 162 by means of the fork formed by the two arms 188 and 190, so preventing the balls from interacting with the converging wall of the piece 178 and locking the spike.

The piece 182 plays as it were the role of a retaining element for the locking means 156 which are therefore not activated (deactivation means).

When the intermediate piece 182 is put in place, the spike 164 can be introduced through the orifice 184a and then the orifice 160a, and is then pushed inside the inner cavity 156 without any risk of activating the locking inside the second part 154 and hence of causing the two parts of the system 150 to be assembled in the locked position.

By virtue of the action of the piece 182, the locking means are temporarily deactivated and so enable the two parts of the system 150 to be temporarily assembled.

When it is desired to separate the two parts, all that is required is simply to withdraw the first part equipped with the spike axially through the two successive orifices and then to withdraw the intermediate piece 182 so that the balls 168 drop down under the action of their weight combined with the action of the elastic means 176. They are then positioned inside the converging piece 178 and enable the two parts of the system 150 to be assembled together in the locked position.

It will be noted that other means or mechanisms for temporarily deactivating the locking means of a prevention system can be envisaged to allow the spike of the first part of the system to be inserted into the orifice without activating the locking.

Furthermore, the embodiment in FIGS. 7 and 8 does not exclude the use of a different temporary assembly mode after having withdrawn the intermediate piece (deactivating means). For example, an opening distinct from the orifice 160a or fixing the first part provided with the spike to an outer face of the second part can be envisaged in addition to the mode in FIGS. 7 and 8.

Several of the temporary assembly modes referred to above may generally be combined in the same prevention system according to the invention.

1. A theft prevention system (10; 50) comprising a first part (12) having a spike (16) intended to pass through the item or packaging containing the item, and a second part (30; 52) that, on the one hand, is provided with an orifice (32b; 54b) so that the spike can be inserted therein and, on the other hand, comprises locking means for preventing the spike from being withdrawn after it has been inserted, characterized in that the two parts are assembled together and held in the assembled position in two possible assembly modes, a first so-called prevention mode in which the spike of the first part is inserted into the orifice of the second part and the locking means are activated so that a user is unable to separate them without using a tool, and a second so-called temporary assembly mode in which the two parts are fixed to each other by means of temporary fixing means, these means being such that a user can separate the two parts from each other without using a tool.

2. The prevention system as claimed in claim 1, characterized in that the second part (30; 52) has at least one opening (32c; 54c) for inserting the spike of the first part into a hollow portion of the second part, said at least one opening being distinct from the orifice, the hollow portion being designed to receive the spike and hold it in a temporary assembly position.

3. The prevention system as claimed in claim 2, characterized in that the spike has a free end (16b) that is arranged inside the hollow portion in the second mode.

4. The prevention system as claimed in claim 2, characterized in that the opening and/or the hollow portion have dimensions that are sufficiently close to those of the spike that the latter is inserted with force and held in the temporary assembly position in the second mode.

5. The prevention system as claimed in claim 2, characterized in that the second part (52) comprises an inner wall (54d) and an inner member (56) attached to the inner wall and defining a hollow portion with the latter to receive the spike.

6. The prevention system as claimed in claim 5, characterized in that the inner wall (54d) is substantially cylindrical and the inner member (56) forms a ring that fits around the wall.

7. The prevention system as claimed in claim 2, characterized in that the second part (30) has an inner member (40) interacting with the spike accommodated in the hollow portion so as to exert a mechanical force on said spike that tends to prevent it from being withdrawn.

8. The prevention system as claimed claim 7, characterized in that the inner member is integral with a wall of the second part.

9. The prevention system as claimed in claim 1, characterized in that the second part (30; 52) has a first face (32a; 54a) in which the orifice (32b; 54b) for inserting the spike is made.

10. The prevention system as claimed in claim 2, characterized in that the opening (32c; 54c) for the temporary assembly is arranged on the first face at a distance from the orifice.

11. The prevention system as claimed in claim 2, characterized in that the second part has a second opposite face (75a) and the opening (75b) for temporary assembly is arranged on the second face.

12. The prevention system as claimed in claim 1, characterized in that in the second temporary assembly mode the spike is inserted into the orifice and the prevention system has a means (182) that temporarily deactivates the locking means (156).

13. The prevention system as claimed in claim 2, characterized in that the second part forms a casing.

14. The prevention system as claimed in claim 13, characterized in that the hollow portion (124) is formed in the casing, at its periphery, and the opening that opens into the hollow portion is made in an outer face of said casing.

15. The prevention system as claimed in claim 1, characterized in that the first part (100) having the spike is temporarily fixed to an outer face of the second part (122).

16. The prevention system as claimed in claim 15, characterized in that the first part is temporarily glued to the second part.

17. The prevention system as claimed in claim 3, characterized in that the opening and/or the hollow portion have dimensions that are sufficiently close to those of the spike that the latter is inserted with force and held in the temporary assembly position in the second mode.

18. The prevention system as claimed in claim 2, characterized in that the second part (30; 52) has a first face (32a; 54a) in which the orifice (32b; 54b) for inserting the spike is made.

19. The prevention system as claimed in claim 2, characterized in that in the second temporary assembly mode the spike is inserted into the orifice and the prevention system has a means (182) that temporarily deactivates the locking means (156).

20. The prevention system as claimed in claim 1, characterized in that the second part forms a casing.
